(19) United States
(12) Patent Application Publication
(10) Pub. No.: US 2012/0098663 A1
(43) Pub. Date: Apr. 26, 2012

(54) TAMPER PROTECTION SYSTEM FOR PREVENTING THEFT OF CARGO

(75) Inventors: Guofu Zhou, Eindhoven (NL); Albericus Antonius Maria Hoevenaars, Eindhoven (NL); Frank Anton Van Abeelen, Eindhoven (NL); Liesbeth Van Pieterson, Eindhoven (NL)

(73) Assignee: KONINKLIJKE PHILIPS ELECTRONICS N.V., EINDHOVEN (NL)

(21) Appl. No.: 13/379,465

(22) PCT Filed: Jun. 18, 2010
(86) PCT No.: PCT/IB2010/052758

§ 371 Date: Dec. 20, 2011

(30) Foreign Application Priority Data
Jun. 26, 2009 (EP) 09163890.8

(51) Int. Cl. G08B 13/14

(52) U.S. Cl. 340/568.1

(57) ABSTRACT

A tamper protection system (1) for preventing theft of cargo comprising a flexible cover sheet (3) for covering said cargo ; a first set of electrically conductive wires (5) distributed along the flexible cover sheet; and a measurement and processing circuitry (6). The measurement and processing circuitry is configured to measure a first measured value (V₁) indicative of a first compound electrical resistance (R₁) of the first set of electrically conductive wires; determine a first difference (ΔV₁) between the first measured value and a first reference value (V_{1ref}); and if the first difference is below a predetermined first threshold value, adjust the first reference value based on the first measured value; otherwise, provide a signal indicative of the first threshold value being exceeded. The tamper protection system in accordance with the present invention hence provides the ability to distinguish between conditions justifying triggering of an alert and conditions falsely giving such an indication.

### FIELD OF THE INVENTION

The present invention relates to a tamper protection system for preventing theft of cargo.

### BACKGROUND OF THE INVENTION

For distribution of goods from one place to another, trucks, freight trains and cargo-ships are often utilized for transportation. The cargo is commonly protected by a flexible cover, for instance a tarpaulin. Since a tarpaulin typically is made of textiles e.g. with water-resistive coatings, or plastic, it may not offer much of protection should an unscrupulous person attempt to open the cargo. By tampering with the tarpaulin, for instance cutting it open with a sharp tool such as a knife, the cargo may hence fairly easily be stolen.

In order to prevent theft of cargo, or at least worsen the conditions for the potential thief, there has been a strive for implementation of alarm systems integrated with the flexible covers. One manner to realize such an alarm system may be to include a number of resistive wires in the tarpaulin connected to a control circuit that measures the resistance of the network formed by these wires. Should one of the wires be cut following the tarpaulin being cut, a corresponding change in the resistance is registered and an alarm may be set off. Such a cargo monitoring alarm system is for instance disclosed in U.S. Pat. No. 6,144,298, which introduces an electronic filament netting including wires electrically connected to an electronic monitoring apparatus so as to create a random electrical connection which defines an initial electrical parameter. A change in the initial electrical parameter, for instance the resistance, is communicated to the electronic monitoring apparatus for monitoring and alerting of any attempt of tampering or theft.

Although U.S. Pat. No. 6,144,298 describes an electronic filament netting which may assist in protecting the cargo by monitoring and alerting of any attempt of tampering or theft, there is a possibility that along with justified alerting, alerts unrelated to tampering with the tarpaulin may be triggered. Accordingly, there is still a need for a monitoring solution for protection of cargo which provides the ability to distinguish between conditions justifying triggering of an alert and conditions falsely giving such an indication, and according to which the above-related drawbacks are at least partly eliminated.

### SUMMARY OF THE INVENTION

According to a first aspect of the invention, the above drawbacks are at least partly met by a tamper protection system for preventing theft of cargo, which tamper protection system comprises a flexible cover sheet for covering the cargo; a first set of electrically conductive wires distributed along a first portion of the flexible cover sheet; and a measurement and processing circuitry connected to the first set of electrically conductive wires. The measurement and processing circuitry is further configured to measure a first measured value indicative of a first compound electrical resistance of the first set of electrically conductive wires; determine a first difference between the first measured value and a first reference value; and if the first difference is below a predetermined first threshold value, adjust the first reference value based on the first measured value; otherwise, provide a signal indicative of the first threshold value being exceeded.

With a tamper protection system for preventing theft of cargo in accordance with the present invention, an ability to distinguish between conditions justifying triggering of an alert and conditions falsely giving such an indication is hence introduced.

The present invention is based on the realization that when a flexible cover sheet for covering cargo carried by for instance a truck or vessel is tampered with, e.g. by cutting across it in order to steal the cargo, wires of a (first) set of electrically conductive wires distributed along a (first) portion of the flexible cover sheet are likely to be cut as well. Such a cut affects a (first) compound electrical resistance of the set of wires. However, the compound electrical resistance may additionally be affected by age and environmental conditions, and may hence vary with time, temperature and/or humidity. The effect on the compound electrical resistance associated with environmental effects is of a different character than the effect associated with tampering with the flexible cover sheet. The former is likely to cause a value of the compound electrical resistance to slowly drift, while the latter on the other hand is likely to cause the value of the compound electrical resistance to rather take a jump. The more wires are being cut, the higher the jump. The inventors have realized that by introducing a (first) reference value with which to compare a measured value indicative of the compound electrical resistance, and allowing this reference value to be adjusted based on the measured value should a (first) difference between the reference value and the measured value not exceed a (first) threshold value, the reference value may be updated to reflect the current environmental conditions affecting the compound electrical resistance. Accordingly, the reference value may vary over time.

Should on the other hand the difference be of a greater magnitude, it is likely that the flexible cover sheet is tampered with and conditions for a justified alert may be considered fulfilled. Accordingly, if the difference exceeds the threshold value, the processing circuitry is configured to provide a signal indicative of the threshold value being exceeded, and an alert may subsequently be triggered based thereon or an OK signal no longer be provided. The threshold value is hence preferably selected such that it may allow changes of the compound electrical resistance resulting from tampering with the flexible cover sheet to exceed the threshold value, but not changes resulting from environmental effects.

Thereby, the present tamper protection system consequently provides the ability to distinguish between conditions justifying triggering of an alert and conditions falsely giving such an indication, whereby triggering of alerts based on compound electrical resistance variations associated with environmental effects rather than related to tampering with the flexible cover sheet may be avoided.

Wires of the set of electrically conductive wires may be of arbitrary length and may for instance comprise one of or a combination of silver coated polyester or nylon, e.g. Statex nylon 117/17 (8 kΩ/m), stainless steel, e.g. Durafil M-Spun (10 kΩ/m and 100 kΩ/m) or Bekinox, carbon coated metal and copper. The theoretical resistance per meter of a wire may hence preferably, although not necessarily, range between 100 Ω/m and 1 MΩ/m, and even more preferably between 1 kΩ/m and 100 kΩ/m. Choosing wires with the aforementioned characteristics may enable for optimization and/or lowering of power consumption without compromising accuracy of measurements. Some or all of the wires may further comprise an insulating layer for avoidance of short circuiting.

The set of electrically conductive wires may, for example, be integrated with the first portion by one of or a combination of weaving, stitching, laminating, printing or gluing. Alternatively, the set of electrically conductive wires may be provided on a separate sheet subsequently attached to e.g. the inside of the flexible cover sheet.

According to one embodiment, the measurement and processing circuitry may be configured to trigger the aforementioned signal indicative of the first threshold value being exceeded only if each of a plurality of differences between reference values and measured values exceed the threshold value. By taking a plurality of samples—i.e. several measurements of the difference—into account for a decision whether or not triggering of an alert may be justified, a single erroneous value of the difference may hence be ignored rather than incorrectly indicating tampering with the flexible cover sheet. A signal indicative of the first threshold value being exceeded is in this case not provided unless at least one additional sample of the difference between a reference value and a measured value also exceeds the threshold value. The additional sample may be any arbitrary previous and/or subsequent measured difference(s). However, it may be advantageous to look at one or several samples within a fairly close time range to provide for an efficient detection of a potential theft attempt.

Furthermore, the plurality of differences may be determined in sequence. Thereby, at least two consecutive samples are taken into consideration prior to deciding whether or not the signal indicative of the threshold value being exceeded should be provided.

There may be different manners in which to arrange the set of electrically conductive wires in relation to the measurement and processing circuitry. According to one embodiment, the set of electrically conductive wires may be electrically connected in parallel to the measurement and processing circuitry. Note that the set of electrically conductive wires being electrically connected in parallel to the measurement and processing circuitry not necessarily indicates that the physical orientation of the wires in relation to each other should be restricted to a parallel disposition. On the contrary, the wires may be arbitrarily distributed in relation to each other, for instance even crossing one another. Wires may make electric contact at crossings or be kept isolated. The latter construction has the advantage that there is no need to make reliable electric connections which may be difficult to achieve in the middle of a tarpaulin where there is e.g. no seam to hide such connections. With wires at least partly forming a netting, e.g. in a warp and weft manner, the size of a possible opening cut with the intention of stealing the cargo is further limited, making it harder yet for the potential thief to cut the flexible cover sheet without also cutting at least one of the wires.

In order to avoid draining of a power supply such as a battery driving the tamper protection system and to keep power consumption at a reasonable level, measurements may be performed intermittently. The processing circuitry may hence be configured to initiate measurements periodically at predetermined time intervals with a frequency of e.g. 1 Hz. According to various embodiments, however, the measurement and processing circuitry may be configured to initiate measurements aperiodically, such as at random time intervals. Measurements at irregular time intervals increase the difficulty for an unscrupulous person to “hack” the tamper protection system, i.e. trying to disable the system by temporarily installing a work-around solution. Such a disablement may be attempted by e.g. measuring voltage and current at terminals of the set of electrically conductive wires to thereby determine the compound electrical resistance, and then provide a replacement resistor during the idle time between two measurements. Implementation of measurements at irregular time intervals, such as randomly, hence worsens the conditions for the potential hacker in that he is not able to predict when the next measurement will take place.

In order to make it harder yet for a potential hacker to disable the tamper protection system, the measurement and processing circuitry may comprise at least a first and a second control unit electrically connected to each other via the set of electrically conductive wires. Thereby, the first and second control unit may communicate with each other, whereby a supplementary feature for preventing attempted theft of the cargo is provided. The communication may for instance be based on an encryption algorithm with a different key for every unique tamper protection system. Since the potential hacker does not know this key, he is not able to temporarily install a replacement for the first or second control unit in his attempts to hack the system.

Additionally, by arranging the first and second control unit to be connected via the set of electrically conductive wires, and preferably separated from each other at different ends of the set of electrically conductive wires, any attacker attempting to hack the tamper protection system by installing a replacement resistor will run into yet another obstacle. In trying to make a replacement connection between the first and second control units, the attacker will be faced with having to access wires disposed at a distance from each other. In order to make access to the wires connecting the first and second control units to the set of electrically conductive wires even more difficult, one or both of the control units may furthermore be integrated in the flexible cover sheet, to thereby stay hidden from the attacker.

Moreover, should any wire connecting the first and second control units to the set of electrically conductive wires simply be cut by a potential thief, the tamper protection system will as described in the foregoing provide a signal indicative of the threshold value being exceeded, whereby an alert may be triggered.

With added functionality to the two control units, yet other advantages may be derived from the tamper protection system. Measurement functionality may be distributed between the two such that either one of, or both, control units for instance is utilized for measurements. One of the control units may for instance be configured to set a current to be provided to the set of electrically conductive wires, while the other control unit may be configured to measure a voltage across the set of electrically conductive wires. Furthermore, the functionality distribution may change over time between the units. According to one embodiment, the measurement and processing circuitry may be configured to initiate measurements based on a synchronization signal, e.g. a binary code, transmitted from the first control unit to the second control unit. A possible scenario may then be that the synchronization signal is transmitted from the first to the second control unit, which initiates the second control unit to switch on/off, for example, the current to the set of electrically conductive wires according to a rhythm dictated by the binary code. Simultaneously, the first control unit measures, for example, the voltage across the set of electrically conductive wires with the same rhythm. Thereby, distribution of the functionality as well as unpredictability in the timing of the measurements may be accomplished, whereby efficient use of the two control units as well as worsened conditions for the potential thief may be accomplished.

One feasible advantageous manner of implementation of the tamper protection system of the present invention may be to utilize voltage measurements across the set of electrically conductive wires. Accordingly, the first reference value may be a voltage, and the measurement and processing circuitry may comprise a first current generating circuitry arranged to provide a first predetermined current to the first set of electrically conductive wires; a first voltage measuring circuitry arranged to measure a first compound voltage across the first set of electrically conductive wires; and a first voltage difference measuring circuitry arranged to detect the first difference between the first compound voltage and the first reference value. Thereby, since the current through the set of electrically conductive wires thus is known, the first compound voltage is indicative of the first compound electrical resistance of the first set of electrically conductive wires. Note that the predetermined current not necessarily needs to remain constant over time. On the contrary, the predetermined current may rather be adjusted, whereby optimal power consumption may be maintained over time. As the compound electrical resistance may change with environmental conditions as well as aging of the set of electrically conductive wires, the predetermined current may be adjusted to compensate for this change. Additionally, the amplitude of the predetermined current may vary irregularly, for example be randomized, whereby a potential hacker would have increased difficulties to disable the tamper protection system in that it is harder to predict dimensions for a replacement resistor.

Generally, the set of electrically conductive wires of the present invention may comprise an arbitrary number of wires ranging from just a few to several hundred wires, e.g. 400. Although an even larger number of wires would allow for a larger portion of the flexible cover sheet to be covered with wires or a larger density of wires, the larger number would possibly lead to a compound electrical resistance change resulting from a cut wire being hard to—in a reliable manner—distinguish from a compound electrical resistance change resulting from environmental effects. That is, the threshold value would in the latter case need to be set relatively low, thus increasing the probability of triggering an alert resulting from environmental changes rather than tampering with the flexible cover sheet. Accordingly, in order to support covering of a larger portion of the flexible cover sheet or forming of a netting pattern worsening the conditions for the potential thief, while keeping down the risk of indicating an unjustified alert, the tamper protection system may further comprise a second set of electrically conductive wires distributed along a second portion of the flexible cover sheet. The measurement and processing circuitry may be connected to the second set of electrically conductive wires and further be configured to measure a second measured value indicative of a second compound electrical resistance of the second set of electrically conductive wires; determine a second difference between the second measured value and a second reference value; and if the second difference is below a predetermined second threshold value, adjust the second reference value based on the second measured value;

otherwise, provide a signal indicative of the second threshold value being exceeded. Thereby, with a second set of electrically conductive wires, the number of wires of the tamper protection system may be increased without compromising the ability to in a reliable manner distinguish compound electrical resistance changes related to environmental effects from compound electrical resistance changes related to tampering with the flexible cover sheet. That is, the respective first and second threshold values may be set relatively high as compared to should only one set of electrically conductive wires be utilized for the same number of wires, thus decreasing the risk of accidentally mistaking a first and/or second compound electrical resistance change resulting from an environmental change for a tampering attempt. Additionally, should a potential hacker attempt to disable the tamper protection system, he may need to match and temporarily install not only one, but two replacement resistors—one for each set of electrically conductive wires.

In order to keep the number of components to a minimum, the second set of electrically conductive wires may be electrically connected in series with the first set of electrically conductive wires. In this manner, a single current may be provided to both the first and second set of electrically conductive wires, whereby a single current generating circuitry may be utilized for both sets of electrically conductive wires. Furthermore, the measurement and processing circuitry may be configured to alternately measure measured values indicative of the first and the second compound electrical resistance. Accordingly, resources may be utilized in an efficient manner. Additionally, provision of the first and/or second signal indicative of the first and/or second threshold being exceeded—which subsequently may trigger an alert—may be based on analyzing whether or not the respective first and second threshold values are both being exceeded. Thereby, triggering of an alert resulting from e.g. a broken wire of either the first or the second set of electrically conductive wires unrelated to tampering of the flexible cover sheet may be avoided.

The wires of the first and/or the second set of electrically conductive wires may generally be physically arbitrarily disposed in relation to each other, and countless distribution patterns of arbitrary orientations are feasible. Furthermore, the first and the second set of electrically conductive wires may be physically arbitrarily disposed in relation to each other, for instance at least partly overlapping one another or even being arranged in a warp and weft manner. Accordingly, the first and the second portion of the flexible cover sheet may be disposed to at least partly coincide. Preferably, at least one wire of the first set of electrically conductive wires may cross at least one wire of the first and/or the second set of electrically conductive wires. Thereby, the first and the second set of electrically conductive wires cooperate to limit the size of a possible opening that may be cut without at the same time cutting at least one of the wires. Moreover, there may be wires with various different orientations within each set of electrically conductive wires. For example, at least one wire of a set of electrically conductive wires may cross at least one other wire of the same set. Thereby the wires within each set cooperate to limit the size of a possible opening that may be cut without at the same time cutting at least one of the wires. Wires of different sets can hence cooperate to further limit the size of these openings by reducing the average distance between the wires.

In order to utilize components related to the first set of electrically conductive wires also for the second set of electrically conductive wires in an efficient manner, the first set of electrically conductive wires may be electrically connected in parallel to the measurement and processing circuitry via a first conductor and a common conductor; and the second set of electrically conductive wires may be electrically connected in parallel to the measurement and processing circuitry via a second conductor and the common conductor. Accordingly, the common conductor is reused for the second set of electrically conductive wires. According to this embodiment fewer components are needed. Furthermore, tampering resulting in the common conductive wire being cut affects measurements of both the first and the second set of electrically conductive wires. Thereby, measurements may indicate both the first and the second threshold value being exceeded, which feedback in turn may form basis for triggering of an alert. Additionally, the first, second and/or common conductors may be integrated, e.g. interwoven, with the flexible cover sheet, e.g. in edge seams, whereby the conductors are kept hidden and hence protected from a potential thief. The conductors are preferably highly conductive and may for instance be constituted of copper wires.

To worsen the conditions for a potential hacker even further, connections of wires of the first and/or second set of electrically conductive wires to the common conductor may be disposed in a shuffled manner. Accordingly, along an extension of the common conductor, a connection to the common conductor for at least one wire of the first set of electrically conductive wires may be disposed in between connections to the common conductor for two wires of the second set of electrically conductive wires. This is an effective method to let the first and second portion of the cover sheet coincide. If an unscrupulous person wants to enter through a part of the cover sheet where the portions overlap, he has to disable both sets of electrically conductive wires—i.e. install a replacement resistor for each set. If only one set is disabled, the remaining set may still protect said part of the cover sheet, although the average distance between the wires will be larger. Only if both sets of electrically conductive wires are disabled may the tamper protection system fail.

As previously indicated, one feasible advantageous manner of implementation of the tamper protection system of the present invention may be to utilize voltage measurements across the sets of electrically conductive wires. Accordingly, the second reference value may be a voltage, and the measurement and processing circuitry may comprise a second current generating circuitry arranged to provide a second predetermined current to at least the second set of electrically conductive wires; a second voltage measuring circuitry arranged to measure a second compound voltage across the second set of electrically conductive wires; and a second voltage difference measuring circuitry arranged to detect the second difference between the second compound voltage and the second reference value. Thereby, since the second current through the second set of electrically conductive wires according to this embodiment is known, the second compound voltage is indicative of the second compound electrical resistance of the second set of electrically conductive wires. It should be noted that for some embodiments, the second current generating circuitry may be represented by the first current generating circuitry, and that the second predetermined current furthermore may be represented by the first predetermined current.

According to a second aspect of the present invention, a tamper protection method for use in a tamper protection system for preventing theft of cargo is provided, comprising a flexible cover sheet for covering said cargo; and a first set of electrically conductive wires distributed along a first portion of the flexible cover sheet. The method comprises measuring a first measured value indicative of a first compound electrical resistance of the first set of electrically conductive wires; determining a first difference between the first measured value and a first reference value; and if the first difference is below a predetermined first threshold value, adjusting the first reference value based on the first measured value; otherwise, providing a signal indicative of the first threshold value being exceeded. With such a method, similar effects as described in conjunction with the first aspect of the invention may be accomplished.

The present invention furthermore relates to a computer program enabling execution of the steps of the aforementioned method when run on a tamper protection system as described in the foregoing.

It is noted that the invention relates to all possible combinations of features recited in the claims.

### BRIEF DESCRIPTION OF THE DRAWINGS

These and other aspects of the present invention will now be described in more detail, with reference to the appended drawings showing embodiment(s) of the invention.

FIG. 1a presents an exemplifying tamper protection system for preventing theft of cargo carried by a transportation vehicle in accordance with a first embodiment of the present invention.

FIG. 1b illustrates the first portion of the flexible cover sheet of the first embodiment of FIG. 1a.

FIG. 1c shows an exemplifying schematic circuit diagram of the first embodiment of FIG. 1a.

FIG. 1d provides a tamper protection system in accordance with the first embodiment of FIG. 1a comprising two control units.

FIG. 2a presents an exemplifying alternative tamper protection system comprising a second set of electrically conductive wires in accordance with a second embodiment of the present invention.

FIG. 2b illustrates an exemplifying schematic circuit diagram of the second embodiment of FIG. 2a.

FIG. 2c shows an alternative disposition of the second set of electrically conductive wires of the second embodiment of FIG. 2a.

FIG. 3a presents an exemplifying alternative tamper protection system comprising a third set of electrically conductive wires in accordance with a third embodiment of the present invention.

FIG. 3b illustrates an alternative shuffled disposition of the sets of electrically conductive wires of the third embodiment of FIG. 3a.

FIG. 3c shows an alternative tamper protection system in accordance with the third embodiment of FIG. 3a comprising two control units.

FIG. 4 provides exemplifying steps of a tamper protection method for use in a tamper protection system in accordance with the first, second or third embodiment of the invention.

### DETAILED DESCRIPTION OF THE EMBODIMENTS

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled addressee. Like reference characters refer to like elements throughout.

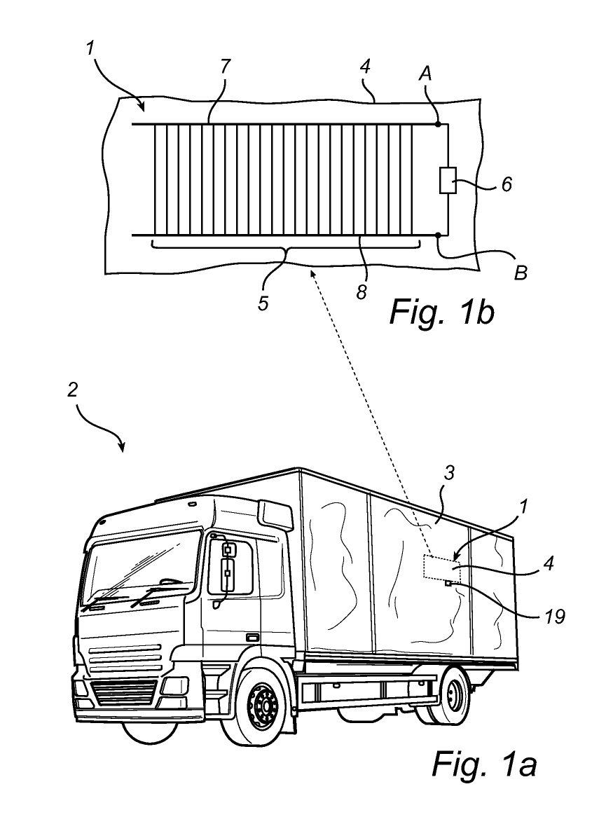

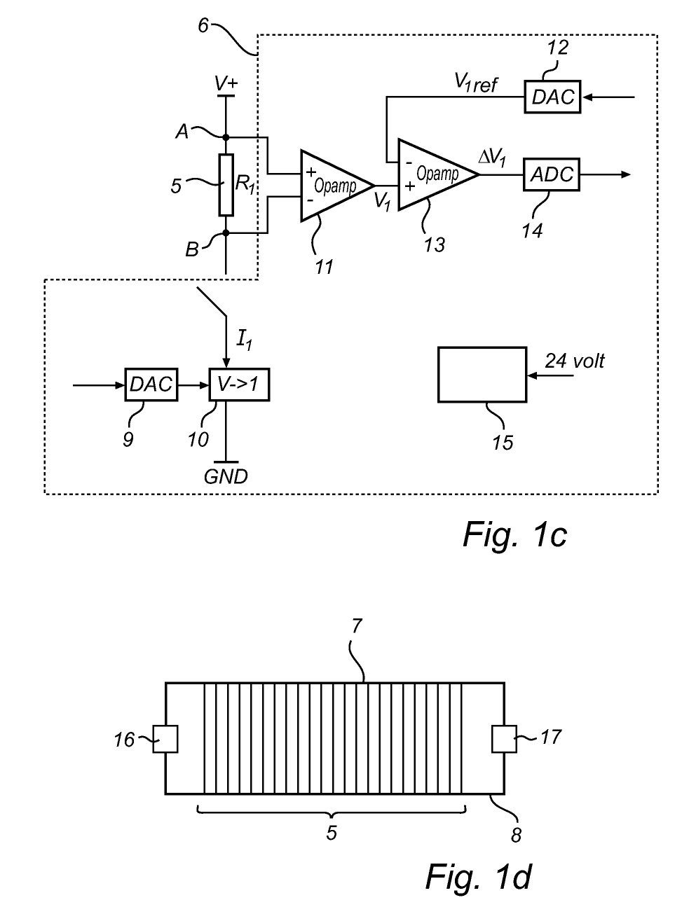

FIG. 1a presents an exemplifying tamper protection system 1 for preventing theft of cargo carried by a transportation vehicle 2 in accordance with a first embodiment of the present invention. The transportation vehicle 2, here a truck, is merely exemplifying and the tamper protection system 1 may likewise be implemented on for instance a transportation vessel such as a boat or any other vehicle intended for carrying cargo, or used to protect cargo that is not being transported but rather is being stored. The tamper protection system 1 may be connected to an alert indicator 19 such that an alert, e.g. an alarm, initiated from the tamper protections system 1 is perceptible. A variety of means 19 for indicating a triggered alert are feasible; the alert indicator 19 may for instance be represented by a visual, optical or audible indicator, and/or a transmitter arranged to communicate the alert to e.g. an alarm center or the driver of the transportation vehicle. The alert indicator 19 may hence be adapted to support communication via e.g. GSM or Bluetooth, and may further—when being arranged to cooperate with a GPS—be adapted to transmit the position of the vehicle 2 along with the alert signal. The trigger indicator 19 is here arranged along the side of the truck 2. The trigger indicator 19 may however be arbitrarily disposed, and may according to alternative embodiments rather be arranged for instance inside the cargo compartment of the truck 2.

The transportation vehicle 2 is provided with a flexible cover sheet 3 for covering at least part of the cargo. Although the flexible cover sheet 3 in the first embodiment is represented by a tarpaulin, the invention is not restricted thereto. According to alternative embodiments, the flexible cover sheet 3 may be constituted of any cloth, draping, canvas cover or arbitrary flexible material suitable for draping over cargo for protection. The flexible cover sheet 3 comprises a first portion 4 comprising the tamper protection system 1, which will be described in further detail in the following in conjunction with FIG. 1b.

FIG. 1b illustrates the first portion 4 of the flexible cover sheet 3 of the first embodiment. Note that the positioning of the tamper protection system 1 and hence the first portion 4 merely is exemplifying, and that the tamper protection system 1 may have an arbitrary positioning. Furthermore, top and bottom of the first portion 4, and hence top and bottom of the tamper protection system 1, may rather than extend merely across a smaller portion of the tarpaulin 3 as shown, coincide with top and bottom of a part of the tarpaulin 3 that covers one side of the truck 2

The tamper protection system 1 comprises a first set of electrically conductive wires 5 distributed along the first portion 4 of the flexible cover sheet 3. It should be emphasized that the first set of electrically conductive wires 5 according to alternative embodiments may extend further or even less both in a sideways and/or a lengthwise direction of the first set of electrically conductive wires 5.

The tamper protection system 1 further comprises a measurement and processing circuitry 6 connected to the first set of electrically conductive wires 5. The measurement and processing circuitry 6 is here for simplicity arranged adjacent to the first set of electrically conductive wires 5; note however that the measurement and processing circuitry 6 alternatively for practical reasons rather may be arranged for instance inside the cargo compartment of the truck 2.

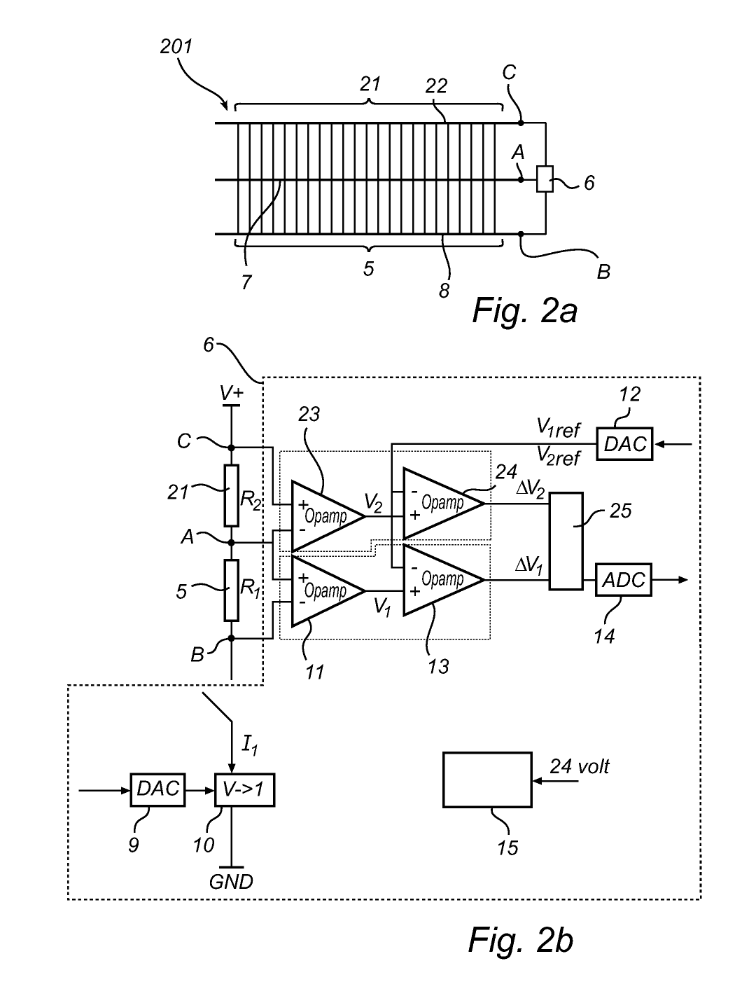

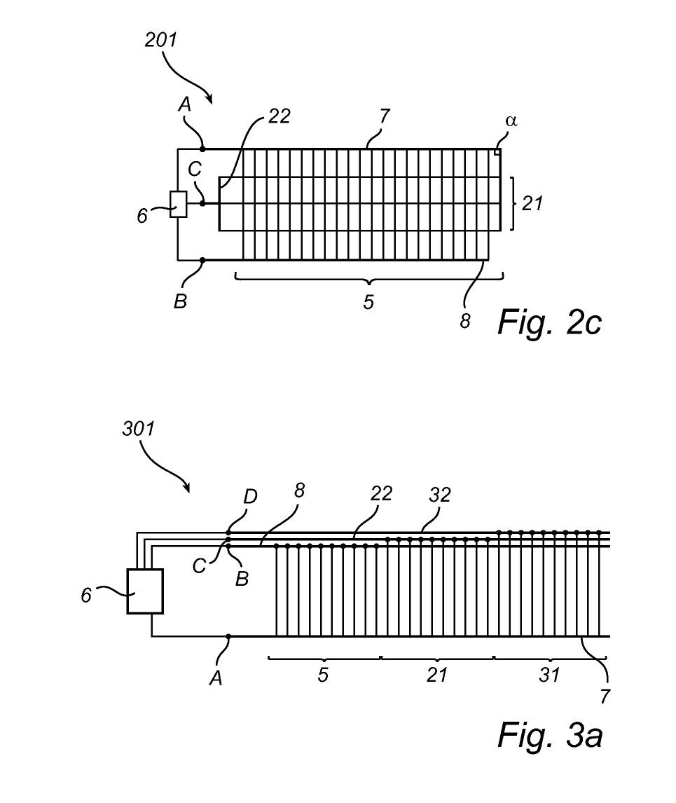

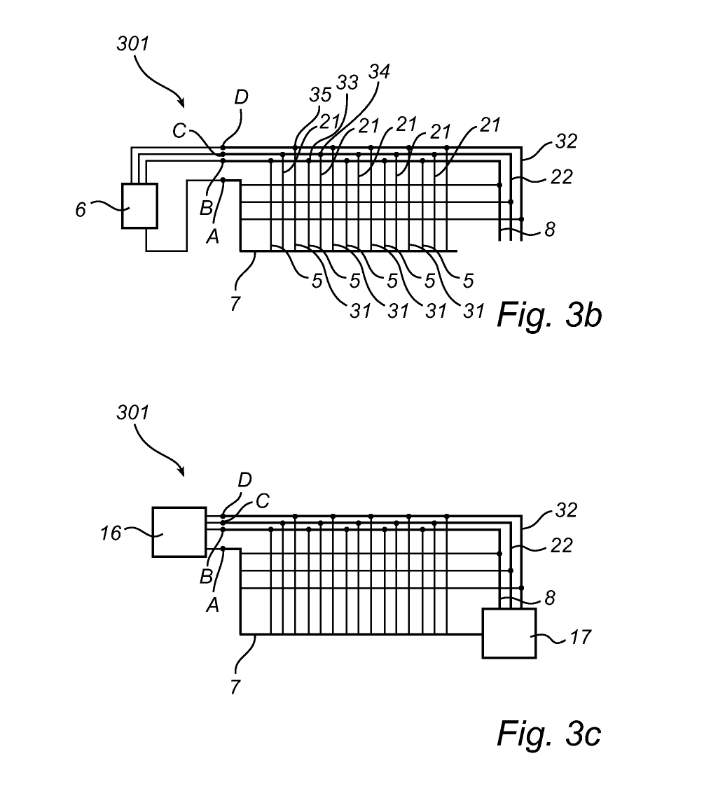

The first set of electrically conductive wires 5 are according to the first embodiment electrically connected in parallel to the measurement and processing circuitry 6 via a common conductor 7 at a terminal A and a first conductor 8 at a terminal B. Note, however, that according to alternative embodiments, the first set of electrically conductive wires 5 may be connected to the measurement and processing circuitry 6 by other means than the common 7 and first 8 conductors, and need not necessarily be electrically connected in parallel to the measurement and processing circuitry 6. Furthermore, although the wires of the first set of electrically conductive wires 5 here are physically disposed in parallel in relation to each other, the invention is not restricted thereto; the wires may alternatively be physically arranged in an arbitrary manner, even crossing one another. Consider for instance an embodiment with the common 7 and/or the first 8 conductor not being straight, as will be further described in conjunction with FIGS. 2c, 3b and 3c.

FIG. 1c shows an exemplifying schematic circuit diagram of the first embodiment of FIG. 1a. The circuit diagram illustrates an implementation of the first set of electrically conductive wires 5 and the measurement and processing circuitry 6 of the tamper protection system 1. The measurement and processing circuitry 6 comprises a first current generating circuitry arranged to provide a first predetermined current I₁ to the first set of electrically conductive wires 5 having a first compound electrical resistance R₁. Here, a digital-to-analogue converter (DAC) 9 is provided to set the first predetermined current I₁ along with a block 10 for converting the output from the DAC 9 from a voltage to a current. The higher the first predetermined current I₁, the bigger may a first compound voltage V₁ across the first set of wires 5 and a subsequent first difference ΔV₁ be as the first compound electrical resistance R₁ changes. On the other hand, should the first current I₁ be set to be relatively high, the first compound voltage V₁ may be almost equal to the power supply V+ making it difficult to detect changes in the first compound electrical resistance R₁. The first predetermined current I₁ is variable and may be set to vary over time at the designers discretion; e.g. to be optimized in relation to the present environmental conditions and/or to optimize power consumption of the tamper protection system 1. Alternatively or additionally, the amplitude of the first current I₁ may be randomized.

In order to measure the first compound voltage V₁ across the first set of electrically conductive wires 5, a first voltage measuring circuitry 11 is provided; here by means of a differential operational amplifier.

The measurement and processing circuitry 6 furthermore comprises a reference voltage circuitry 12—here a digital-to-analogue converter—for provision of a first reference value V_{1ref}. For detection of the first difference ΔV₁ between the first compound voltage V₁ and the first reference value V_{1ref}, a first voltage difference measuring circuitry 13 is provided. Here, the first voltage difference measuring circuitry 13 is implemented by means of a differential operational amplifier. Furthermore, an analogue-to-digital converter (ADC) 14 is provided for measurement of the first difference ΔV₁, to thereby enable for the present first compound electrical resistance R₁ to be derived based on the first predetermined current I₁ and the first reference value V_{1ref}.

Electric power for the tamper protection system 1 is provided by a power supply 15. This may be the battery of the vehicle 2, typically a 24 V battery for a truck. It may also be a separate power supply allowing the system 1 to operate independently, e.g. on a trailer that is parked without being attached to a powered vehicle. In the latter case, the separate power supply allows the system 1 to operate without draining the vehicle battery when the engine is not running

FIG. 1d provides a tamper protection system 1 in accordance with the first embodiment comprising a first control unit 16 and a second control unit 17. The two control units 16, 17—which may each constitute or comprise a chip—are electrically connected to each other via the first set of electrically conductive wires 5, and more specifically through the common conductor 7 and the first conductor 8. The first 16 and second 17 control units are here separately disposed from each other, on different sides of the first set of electrically conductive wires 5. According to alternative embodiments, however, the two control units 16, 17 may be disposed more closely in relation to one another. The first 16 and second 17 control units of FIG. 1d are configured to communicate with each other based on an encryption algorithm with a key that is unique for the specific tamper protection system 1. As a result, a potential hacker is not able to temporarily install a replacement for the first 16 or second 17 control unit in his attempts to hack the system 1. Furthermore, the measurement and processing circuitry 6 may be configured to initiate measurements based on a synchronization signal transmitted from the first control unit 16 to the second control unit 17.

FIG. 2a presents an exemplifying alternative tamper protection system 201 comprising a second set of electrically conductive wires 21 in accordance with a second embodiment of the present invention. The second set of electrically conductive wires 21—which may exhibit similar characteristics as the first set 5—is distributed along a second portion of the flexible cover sheet 3. In FIG. 2a, the first portion 4 and the second portion are disposed adjacent to each other, and wires of the second set of electrically conductive wires 21 are electrically connected in series with wires of the first set of electrically conductive wires 5. Such an electrical connection in series as here illustrated is not mandatory; the first portion 4 and the second portion—and furthermore the first 5 and the second 21 set of electrically conductive wires—may be arbitrarily disposed in relation to each other, and alternative dispositions will be evident further on. The second set of electrically conductive wires 21 is here electrically connected in parallel to the measurement and processing circuitry 6 via the common conductor 7 at the terminal A and a second conductor 22 via a terminal C. The second conductor 22 may exhibit similar characteristics as the common 7 and/or first conductor 8. It should furthermore be emphasized that a number of wires of the second set of electrically conductive wires 21 by no means is restricted to be equal to the number of wires of the first set of electrically conductive wires 5.

FIG. 2b illustrates an exemplifying schematic circuit diagram of the second embodiment of FIG. 2a. The circuit diagram illustrates an implementation of the first 5 and the second 21 set of electrically conductive wires, and the measurement and processing circuitry 6 of the tamper protection system 201. The first current generating circuitry, i.e. the DAC 9 and the block 10, is arranged to provide the first predetermined current I₁ not only to the first set of electrically conductive wires 5, but also to the second set of electrically conductive wires 21 having a second compound electrical resistance R₂. In order to measure the second compound voltage V₂ across the second set of electrically conductive wires 21, a second voltage measuring circuitry 23 is provided; here by means of a differential operational amplifier. The reference voltage circuitry 12 is here adapted for provision of a second reference value V_{2ref}. For detection of a second difference ΔV₂ between the second compound voltage V₂ and the second reference value V_{2ref}, a second voltage difference measuring circuitry 24 is provided. Here, the second voltage difference measuring circuitry 24 is implemented by means of a differential operational amplifier.

In order to e.g. utilize fewer components and to be able to acquire the first difference ΔV₁ and the second difference ΔV₂ alternately, the measurement and processing circuitry 6 furthermore comprises a multiplexer 25. Here, the multiplexer 25 is illustrated to comprise two inputs, one for each difference ΔV₁, ΔV₂. The multiplexer 25 may however according to alternative embodiments be dimensioned to comprise many more inputs, such that the multiplexer 25 e.g. may support an arbitrary number of sets of electrically conductive wires.

The ADC 14 is configured for measurement of the second difference ΔV₂, to thereby enable for the present second compound electrical resistance R₂ to be derived based on the first predetermined current I₁ and the second reference value V_{2ref}. It should be emphasized that the ability to utilize the first predetermined current I₁ to be fed to the second set of electrically conductive wires 21 is feasible in that the wires of the first 5 and second 21 sets of electrically conductive wires here are electrically connected in series. According to other embodiments, the second set of electrically conductive wires 21 may require an individual current generating circuitry and hence an individual predetermined current, which is the case for instance for the illustration of FIG. 2c to be described in the following.

FIG. 2c shows an alternative disposition of the second set of electrically conductive wires 21 of the second embodiment of FIG. 2a. Here, the first portion 4 and the second portion are disposed to coincide, and wires of the first set of electrically conductive wires 5 cross wires of the second set of electrically conductive wires 21. The first 5 and second 21 sets of electrically conductive wires are here both integrated with the flexible cover sheet 3. Alternatively, however, the first 5 and/or the second 21 set of electrically conductive wires may be integrated with a respective separate fabric which subsequently may be attached to the flexible cover sheet 3. The wires of the first 5 and second 21 set of electrically conductive wires are isolated from each other where the wires cross, such that short circuiting is avoided.

The common conductor 7 is here disposed in a bent manner, with a right angle a allowing for the wires of the second set of electrically conductive wires 21 to cross the wires of the first set of electrically conductive wires 5 perpendicularly. It should be noted that the angle a according to other embodiments may take on other values, and that the common conductor 7 further may comprise more than one such angle a. Accordingly, crossing of wires need not necessarily be perpendicular. As was the case in FIG. 2b, the first set of electrically conductive wires 5 is electrically connected in parallel to the measurement and processing circuitry 6 via the common conductor 7 at the terminal A and the first conductor 8 at the terminal B, while the second set of electrically conductive wires 21 is electrically connected in parallel to the measurement and processing circuitry 6 via the common conductor 7 at the terminal A and the second conductor 22 at the terminal C.

FIG. 3a presents an exemplifying alternative tamper protection system 301 comprising a third set of electrically conductive wires 31 in accordance with a third embodiment of the present invention. The third set of electrically conductive wires 31—which may exhibit similar characteristics as the first set 5—is distributed along a third portion of the flexible cover sheet 3. In FIG. 3a, the first 4, second and third portions are disposed adjacent to each other, such that the second set of electrically conductive wires 21 is disposed in between the first 5 and the third 31 set of electrically conductive wires. Here, all wires of the first 5, second 21 and third 31 sets of electrically conductive wires are arranged in parallel rather than in series or crossed, whereby the tamper protection system 1 exhibits wires distributed in a sidewise direction.

The third set of electrically conductive wires 31 is here electrically connected in parallel to the measurement and processing circuitry 6 via the common conductor 7 at the terminal A and a third conductor 32 at a terminal D. The third conductor 32 may exhibit similar characteristics as the common 7, first 8 and/or the second conductor 22. As described in conjunction with the second embodiment of FIG. 2, the first set of electrically conductive wires 5 is electrically connected in parallel to the measurement and processing circuitry 6 via the common conductor 7 at the terminal A and the first conductor 8 at the terminal B, while the second set of electrically conductive wires 21 is electrically connected in parallel to the measurement and processing circuitry 6 via the common conductor 7 at the terminal A and the second conductor 22 at the terminal C.

FIG. 3b illustrates an alternative shuffled disposition of the sets of electrically conductive wires 5, 21, 31 of the third embodiment of FIG. 3a. Here, the first 4, second and third portions are disposed to coincide, and the common 7, first 8, second 22 and third 32 conductors are here arranged in a bent manner to enable wires of the respective sets of electrically conductive wires 5, 21, 31 to cross one another. By shuffled disposition is meant that a connection 33 to the common conductor 7 for at least one wire of e.g. the first set of electrically conductive wires 5, may be disposed in between connections 34, 35 to the common conductor 7 for two wires of the second 21 and/or the third 31 set of electrically conductive wires.

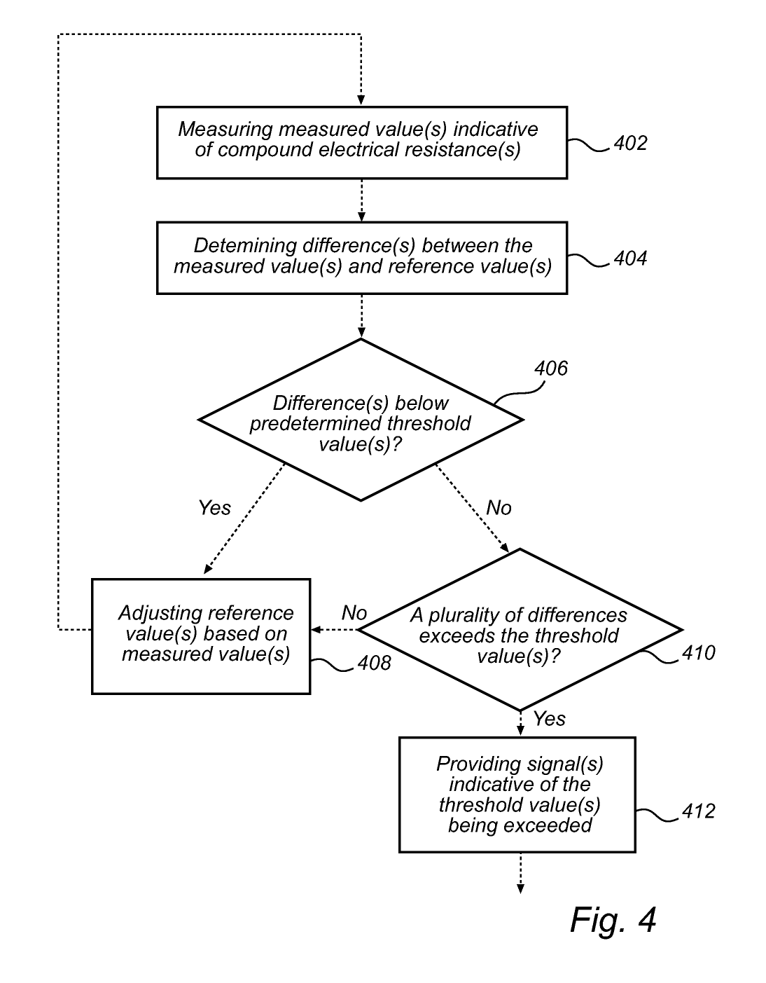

FIG. 3c shows an alternative tamper protection system 301 in accordance with the third embodiment of FIG. 3a, comprising the first 16 and the second 17 control unit. FIG. 4 provides exemplifying steps of a tamper protection method for use in a tamper protection system according to any of the above embodiments. As an example, consider the tamper protection system 301 in accordance with the third embodiment of FIG. 3b, in conjunction with the schematic circuit diagram of FIG. 1c. It should be noted that the steps not necessarily need to be performed in the order presented. On the contrary, the steps may be performed in any order at the designer's discretion, and may even partly be performed simultaneously. It should further be noted that steps may be repeated in a continuous loop for as long as the tamper protection system 301 is active.

Since the tamper protection system 301 of FIG. 3c comprises three sets of electrically conducive wires 5, 21, 31, the measurement and processing circuitry 6 is here configured to alternate measurements of the respective sets 5, 21, 31. The measurements are alternated sequentially, but may according to alternative embodiments be alternated randomized. Furthermore, in order to maintain power consumption within the tamper protection system 301 at an acceptable level, the measurement and processing circuitry 6 is here configured such that measurements are initiated intermittently. A suitable frequency for measurements may for instance be 1 Hz; however, randomized timing of these time intervals may be preferable.

Since measurements of the respective second 21 and third 31 sets of electrically conductive wires resembles those performed for the first set of electrically conductive wires 5, only measurements related to the first set of electrically conductive wires 5 will be described in detail in the following.

Initially, an initial first reference value indicative of an expected first compound electrical resistance R₁ of the first set of electrically conductive wires 5 may need to be established. According to the exemplifying implementation of FIG. 1c, the reference value may possibly—although not necessarily—be represented by a voltage, and the initial first reference value is hence represented by the first reference value V_{1ref}. The initial first reference value V_{1ref} may be calibrated at any arbitrary point in time, for instance when the transportation vehicle 2 stops driving. It should be noted that the second reference value V_{2ref} is associated with the second compound electrical resistance R₂ of the second set of electrically conductive wires 21 and that a third reference value V_{3ref} is associated with an expected third compound electrical resistance R₃ of the third set of electrically conductive wires 31, whereby the respective reference values V_{1ref}, V_{2ref}, V_{3ref} may need to be calibrated—and subsequently handled—separately.

In a first step 402, a first measured value—i.e. the first compound voltage V₁—indicative of the first compound electrical resistance R₁ of the first set of electrically conductive wires 5 is measured. Next, the first difference ΔV₁ between the first compound voltage V₁ and the first reference value V_{1ref} is be determined in step 404. The measurement and processing circuitry 6 then analyzes in step 406 whether or not the first difference ΔV₁ is below a predetermined first threshold value. The first threshold value is preferably selected such that it may allow rather large changes of the compound electrical resistance R₁ assumingly resulting from tampering with the flexible cover sheet 3 to exceed the first threshold, but not rather small changes assumingly resulting from environmental effects.

Should the first difference ΔV₁ be found to have a value below the first threshold value, the first reference value V_{1ref} is adjusted in step 408 based on the first compound voltage V₁. Accordingly, the first reference value V_{1ref} is adjusted to take on the value of the first compound voltage V₁, to thereby exhibit a value reflecting the latest known environmental conditions.

Should on the other hand the first difference ΔV₁ in step 410 be found to have a value exceeding the first threshold value, it is likely that an attempt to steal cargo is underway. Here, in order to prevent an erroneous single measurement value from triggering an unjustified alert, a plurality of measurements of the first difference ΔV₁ is taken into consideration. Accordingly, steps 402-406 are repeated; alternatively a previous first difference ΔV₁ may be considered. Only if at least two samples—here two consecutive samples—of the first difference ΔV₁ exceeds the first threshold value, will the measurement and processing circuitry 6 in step 412 provide a signal indicative of the first threshold value being exceeded. The signal may then be utilized for triggering an alert seemingly indicating tampering of the flexible cover sheet 3, which in turn may be communicated by the alert indicator 19.

Measurements related to the first set of electrically conductive wires 5 as described in the foregoing may in a similar manner be performed in relation to the second 21 and third 31 sets of electrically conductive wires.

The person skilled in the art realizes that the present invention by no means is limited to the preferred embodiments described above. On the contrary, many modifications and variations are possible within the scope of the appended claims. Variations to the disclosed embodiments can be understood and effected by the skilled addressee in practicing the claimed invention, from a study of the drawings, the disclosure, and the appended claims. In the claims, the word “comprising” does not exclude other elements or steps, and the indefinite article “a” or “an” does not exclude a plurality.

1. A tamper protection system (1) for preventing theft of cargo, the tamper protection system (1) comprising:
a flexible cover sheet (3) for covering the cargo;
a first set of electrically conductive wires (5) distributed along a first portion (4) of the flexible cover sheet (3); and
a measurement and processing circuitry (6) connected to the first set of electrically conductive wires (5) and configured to:
measure (402) a first measured value (V₁) indicative of a first compound electrical resistance (R₁) of the first set of electrically conductive wires (5);
determine (404) a first difference (ΔV₁) between the first measured value (V₁) and a first reference value (V_{1ref}); and
if (406) the first difference (ΔV₁) is below a predetermined first threshold value, adjust (408) the first reference value (V _{1ref}) based on the first measured value(V₁);
otherwise (410), provide (412) a signal indicative of the first threshold value being exceeded.

2. The tamper protection system (1) according to claim 1, wherein the measurement and processing circuitry (6) is configured to trigger the signal only if each of a plurality of first differences (ΔV₁) exceeds the first threshold value.

3. The tamper protection system (1) according to claim 2, wherein the plurality of first differences (ΔV₁) are determined in sequence.

4. The tamper protection system (1) according to claim 1, wherein the first set of electrically conductive wires (5) are electrically connected in parallel to the measurement and processing circuitry (6).

5. The tamper protection system (1) according to claim 1, wherein the measurement and processing circuitry (6) is configured to initiate measurements at irregular time intervals.

6. The tamper protection system (1) according to claim 1, wherein the measurement and processing circuitry (6) comprises at least a first (16) and a second (17) control unit electrically connected to each other via the first set of electrically conductive wires (5).

7. The tamper protection system (1) according to claim 6, wherein the measurement and processing circuitry (6) is configured to initiate measurements based on a synchronization signal transmitted from the first control unit (16) to the second control unit (17).

8. The tamper protection system (1) according to claim 1, wherein the first reference value (V_{1ref}) is a voltage, and the measurement and processing circuitry (6) comprises:
a first current generating circuitry (9, 10) arranged to provide a first predetermined current (I₁) to the first set of electrically conductive wires (5);
a first voltage measuring circuitry (11) arranged to measure a first compound voltage (V,) across the first set of electrically conductive wires (5); and
a first voltage difference measuring circuitry (13) arranged to detect the first difference (ΔV₁) between the first compound voltage (V₁) and the first reference value (V_{1ref}).

9. The tamper protection system (201) according to claim 1, further comprising a second set of electrically conductive wires (21) distributed along a second portion of the flexible cover sheet (3), the measurement and processing circuitry (6) being connected to the second set of electrically conductive wires (21) and configured to:
measure (402) a second measured value (V₂) indicative of a second compound electrical resistance (R₂) of the second set of electrically conductive wires (21);
determine (404) a second difference (ΔV₂) between the second measured value (V₂) and a second reference value (V_{2ref}); and
if (406) the second difference (ΔV₂) is below a predetermined second threshold value, adjust (408) the second reference value (V7_{2ref}) based on the second measured value (V₂);
otherwise (410), provide (412) a signal indicative of the second threshold value being exceeded.

10. The tamper protection system (201) according to claim 9, wherein the first (4) and the second portion are disposed to at least partly coincide, and at least one wire of the first set of electrically conductive wires (5) cross at least one wire of the first (5) and/or the second (21) set of electrically conductive wires.

11. The tamper protection system (201) according to claim 9, wherein:
the first set of electrically conductive wires (5) are electrically connected in parallel to the measurement and processing circuitry (6) via a first conductor (8) and a common conductor (7); and
the second set of electrically conductive wires (21) are electrically connected in parallel to the measurement and processing circuitry (6) via a second conductor (22) and the common conductor (7).

12. The tamper protection system (201) according to claim 11, wherein, along an extension of the common conductor (7), a connection (33) to the common conductor (7) for at least one wire of the first set of electrically conductive wires (5) is disposed in between connections (34) to the common conductor (7) for two wires of the second set of electrically conductive wires (21).

13. The tamper protection system (201) according to claim 12, wherein the second reference value (V_{2ref}) is a voltage, and the measurement and processing circuitry (6) comprises:
a second current generating circuitry arranged to provide a second predetermined current to the second set of electrically conductive wires (21);
a second voltage measuring circuitry (23) arranged to measure a second compound voltage (V₂) across the second set of electrically conductive wires (21); and
a second voltage difference measuring circuitry (24) arranged to detect the second difference (ΔV₂) between the second compound voltage (V₂) and the second reference value (V_{2ref}).

14. A tamper protection method for use in a tamper protection system (1) for preventing theft of cargo, the tamper protection system comprising:
a flexible cover sheet (3) for covering the cargo; and
a first set of electrically conductive wires (5) distributed along a first portion (4) of the flexible cover sheet (3),
the method comprising:
measuring (402) a first measured value (V₁) indicative of a first compound electrical resistance (R₁) of the first set of electrically conductive wires (5);
determining (404) a first difference (ΔV_{'}) between the first measured value (V₁) and a first reference value (V_{1ref}); and
if (406) the first difference (ΔV_{'}) is below a predetermined first threshold value, adjusting (408) the first reference value (V_{1ref}) based on the first measured value (V₁);
otherwise (410), providing (412) a signal indicative of the first threshold value being exceeded.

15. A computer program enabling execution of the method according to claim 14 when run on measurement and processing circuitry comprised in a tamper protection system (1).
